(19) United States
(12) Patent Application Publication
(10) Pub. No.: US 2025/0148431 A1
(43) Pub. Date: May 8, 2025

(54) AGENT-BASED CARBON EMISSION REDUCTION SYSTEM

(71) Applicant: NEC Laboratories America, Inc., Princeton, NJ (US)

(72) Inventors: Haoyu Wang, Plainsboro, NJ (US); Christopher A. White, Neshanic Station, NJ (US); Haifeng Chen, West Windsor, NJ (US); LuAn Tang, Cranbury, NJ (US); Zhengzhang Chen, Princeton Junction, NJ (US); Xujiang Zhao, Hillsborough, NJ (US)

(21) Appl. No.: 18/938,823

(22) Filed: Nov. 6, 2024

Related U.S. Application Data
(60) Provisional application No. 63/596,719, filed on Nov. 7, 2023.

(51) Int. Cl. G06Q 10/30; G06Q 10/0637

(52) U.S. Cl. CPC G06Q 10/30; G06Q 10/0637

(57) ABSTRACT

Systems and methods for an agent-based carbon emission reduction system. A carbon product of a supply chain system can be limited below a carbon product threshold by performing a corrective action to monitored entities based on a calculated carbon emission. The carbon emission can be calculated based on carbon-relevant data and a calculation route by utilizing an agent-based simulation model that simulates a learned relationship between a supply chain system and the carbon-relevant data. The calculation route can be determined based on the carbon-relevant data based on a relevance of a carbon product contribution of monitored entities to a goal of the monitored entities. Carbon-relevant data can be extracted from the monitored entities.

### RELATED APPLICATION INFORMATION

This application claims priority to U.S. Provisional App. No. 63/596,719, filed on Nov. 7, 2023, incorporated herein by reference in its entirety.

### BACKGROUND

### Technical Field

The present invention relates to reducing carbon footprint of supply chain systems, and more particularly to an agent-based carbon emission reduction system.

### Description of the Related Art

In today's globalized economy, supply chain systems have grown in complexity, spanning multiple countries and involving multiple layers of intermediaries. As supply chain systems grow, concerns about climate change and environmental sustainability intensify for these supply chain systems.

### SUMMARY

According to an aspect of the present invention, a computer-implemented method is provided for reducing carbon emissions using an agent-based system, including, extracting carbon-relevant data from monitored entities, determining a calculation route based on the carbon-relevant data based on a relevance of a carbon product contribution of the monitored entities to a goal of the monitored entities, calculating a carbon emission based on the carbon-relevant data and the calculation route by utilizing an agent-based simulation model that simulates a learned relationship between a supply chain system and the carbon-relevant data, and performing a corrective action to the monitored entities based on the carbon emission to limit a carbon product of a supply chain system below a carbon product threshold.

According to another aspect of the present invention, a system is provided including, a memory device, one or more processor devices operatively coupled with the memory device to extract carbon-relevant data from monitored entities, determine a calculation route based on the carbon-relevant data based on a relevance of a carbon product contribution of the monitored entities to a goal of the monitored entities, calculate a carbon emission based on the carbon-relevant data and the calculation route by utilizing an agent-based simulation model that simulates a learned relationship between a supply chain system and the carbon-relevant data, and perform a corrective action to the monitored entities based on the carbon emission to limit a carbon product of a supply chain system below a carbon product threshold.

According to yet another aspect of the present invention, a non-transitory computer program product is provided including a computer-readable storage medium having program code for an agent-based carbon emission reduction system, wherein the program code when executed on a computer causes the computer to extract carbon-relevant data from monitored entities, determine a calculation route based on the carbon-relevant data based on a relevance of a carbon product contribution of the monitored entities to a goal of the monitored entities, calculate a carbon emission based on the carbon-relevant data and the calculation route by utilizing an agent-based simulation model that simulates a learned relationship between a supply chain system and the carbon-relevant data, and perform a corrective action to the monitored entities based on the carbon emission to limit a carbon product of a supply chain system below a carbon product threshold.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for reducing carbon emissions using an agent-based system, in accordance with an embodiment of the present invention;

FIG. 2 is a flow diagram showing a detailed view of the method of determining a calculation route based on the carbon-relevant data based on a relevance of a carbon product contribution of the monitored entities to a goal of the monitored entities, in accordance with an embodiment of the present invention;

FIG. 3 is a block diagram illustrating a system for an agent learning appropriate actions based on a state machine, in accordance with an embodiment of the present invention;

FIG. 4 is a block diagram showing a system implementing a practical application of the agent-based carbon emission reduction system, in accordance with an embodiment of the present invention;

FIG. 5 is a block diagram showing a computing device implementing the agent-based carbon emission reduction system, in accordance with an embodiment of the present invention; and

FIG. 6 is a block diagram illustrating deep learning neural networks for the agent-based carbon emission reduction system, in accordance with an embodiment of the present invention.

### DETAILED DESCRIPTION OF PREFERRED EMBODIMENTS

In accordance with embodiments of the present invention, systems and methods are provided for an agent-based carbon emission reduction system (MOGI).

In an embodiment, a carbon product of a supply chain system can be limited below a carbon product threshold by performing a corrective action to monitored entities based on a calculated carbon emission. The carbon emission can be calculated based on carbon-relevant data and a calculation route by utilizing an agent-based simulation model that simulates a learned relationship between a supply chain system and the carbon-relevant data. The calculation route can be determined based on the carbon-relevant data based on a relevance of a carbon product contribution of monitored entities to a goal of the monitored entities. Carbon-relevant data can be extracted from the monitored entities.

In an embodiment, the corrective action can include changing an operational parameter of an application or hardware component (for example, an operating speed) for the supply chain system, halting and/or restarting an application for the supply chain system, halting and/or rebooting a hardware component for the supply chain system, changing an environmental condition for the supply chain system, etc.

Other methods of carbon emission calculation for complex supply chain system often rely on static simplified models or average based calculation methods, that cannot capture the accurate relationships within the supply chain system. Therefore, there are several major problems for accurate carbon emission calculation in supply chain system which includes: many existing models use generalized data and average based calculation methods which cannot reflect the accurate carbon emission related to each product in supply chain system; and supply chain systems are not static and other methods cannot handle dynamic supply chain changes for calculating carbon emission. Supply chain systems evolve based on various factors such market demand, geopolitical events, and other manufacturing variations.

To bridge the gap, the present embodiments present an agent-based simulation tool (MOGI) for carbon emission calculation in complex supply chain system. MOGI decomposes the complex supply chain system into several core parts which include: an agent, resources, and an entity topology, to realize the fine-grain level product driven carbon emission calculation. The decomposition can track each product in detail and then apply product-based carbon emission calculation method to reach high calculation accuracy. Additionally, MOGI can include state machines and time synchronization organizers in each agent to collect and simulate the dynamic changes in supply chain system to guarantee the accuracy in calculation. Furthermore, MOGI can generate various simulations which can be visualized in real-time.

By focusing on each product, MOGI can trace the journey in the whole supply chain system, enabling a precise product-based carbon emission calculation method. This granularity can capture the changes of each product's carbon footprint, leading to high accuracy in the overall carbon emission.

Another major advantage of MOGI is on capturing dynamic nature of supply chains, where conditions and variables can change rapidly. MOGI incorporates state machines within each agent to capture the mechanism for dynamic changes in the system. The state machines can ensure that the tool can adapt to and simulate the ever-evolving changes in the supply chain system. This adaptability maintains the accuracy of the carbon emission calculations with dynamic changes.

MOGI can generate accurate carbon emission calculation for complex supply chain system considering the dynamic changes in the supply chain. Compared to other solutions, it includes the following advantages:

MOGI can work on the product-level carbon emission calculation method to achieve better accuracy. MOGI uses simulation-based calculation to consider dynamic changes in supply chain system, where most of the state-of-the-art cannot handle such dynamic changes. MOGI allows users to explore various “what-if” scenarios, assessing the potential carbon impact of different supply chain operations. MOGI can be applied to a large scale of supply chain system. MOGI provides many detailed information to explain the simulation-based calculation results. With detailed explanations, the user can understand the simulated results and take out correct business operations to deal with them.

Thus, the present embodiments can improve carbon emission reduction systems by considering dynamic changes in the supply chain system which achieves better accuracy in carbon emission calculation and provides explainable calculation results.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

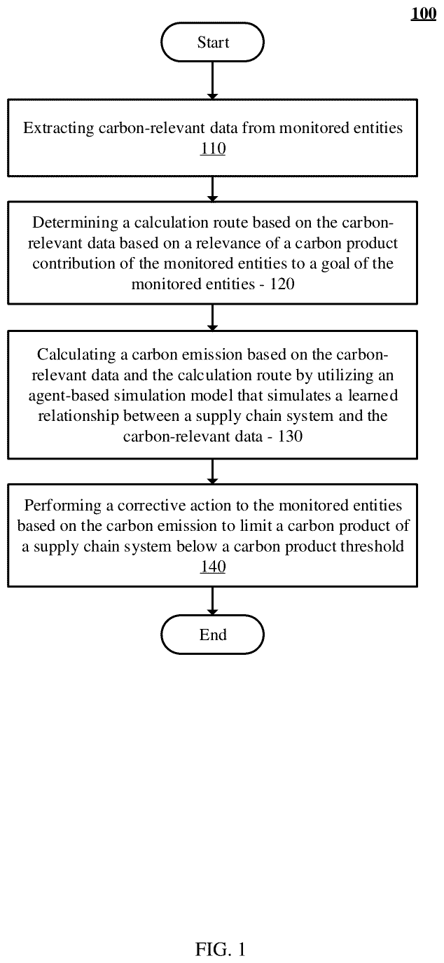

Referring now in detail to the figures in which like numerals represent the same or similar elements and initially to FIG. 1, a high-level overview of a computer-implemented method for reducing carbon emissions using an agent-based system is illustratively depicted in accordance with an embodiment of the present invention.

In an embodiment, a carbon product of a supply chain system can be limited below a carbon product threshold by performing a corrective action to monitored entities based on a calculated carbon emission. The carbon emission can be calculated based on carbon-relevant data and a calculation route by utilizing an agent-based simulation model that simulates a learned relationship between a supply chain system and the carbon-relevant data. The calculation route can be determined based on the carbon-relevant data based on a relevance of a carbon product contribution of monitored entities to a goal of the monitored entities. Carbon-relevant data can be extracted from the monitored entities.

In an embodiment, the corrective action can include changing an operational parameter of an application or hardware component (e.g., an operating speed, workflow, etc.) for the supply chain system, halting and/or restarting an application for the supply chain system, halting and/or rebooting a hardware component for the supply chain system, changing an environmental condition for the supply chain system, etc.

Referring now to block 110 of FIG. 1 showing a method of extracting carbon-relevant data from monitored entities, in accordance with an embodiment of the present invention.

The process begins with the compilation of carbon-relevant data from the monitored entities in the supply chain system. The monitored entities can include every part of the supply chain system such as raw material suppliers, shippers, product distributors, etc. Relevant data regarding the monitored entities can be stored in respective monitored entity profiles that are stored in a profile database.

Each monitored entity profile can include information such as location, products or services provided, historical carbon emission data, goals, and other carbon-relevant data. This carbon-relevant data can include transportation details, energy consumption metrics, production volumes, etc. In an embodiment, the carbon-relevant data can be collected by sensors. In another embodiment, the carbon-relevant data can be obtained from historical data.

Referring now to block 120 of FIG. 1 showing a method of determining a calculation route based on the carbon-relevant data based on a relevance of a carbon product contribution of the monitored entities to a goal of the monitored entities, in accordance with an embodiment of the present invention.

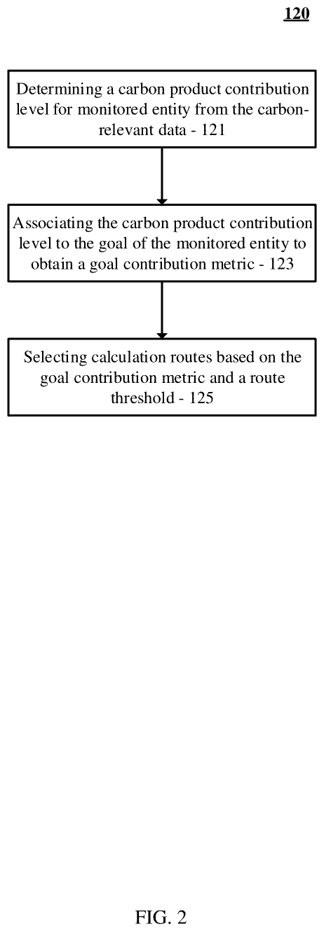

MOGI can automatically adapt to multiple calculation routes, which can be tailored to different types of supply chain systems or carbon-relevant data sources by utilizing the agent-based simulation model that can learn a relevance of the carbon contribution of the monitored entities to a goal of the monitored entities. This is shown in more detail in FIG. 2. In another embodiment, decision-making entities can select a suitable calculation route.

Referring now to FIG. 2, a flow diagram showing a detailed view of the method of determining a calculation route based on the carbon-relevant data based on a relevance of a carbon product contribution of the monitored entities to a goal of the monitored entities, in accordance with an embodiment of the present invention

The calculation routes can include a simulation-based calculation and an equation-based calculation. The calculation routes can dynamically change based on the current carbon relevant data provided by the monitored entities. The agent can dynamically change the current calculation route.

Referring now to block 121 of FIG. 2 showing a method of determining a carbon product contribution level for monitored entity from the carbon-relevant data, in accordance with an embodiment of the present invention.

The carbon product contribution (CPC) level can include a flag such as high or low depending on the carbon product contribution data collected for the monitored entity in relation to the entirety of the supply chain system.

The CPC level can be represented in terms of a color scheme based on the severity of the level. In an embodiment, the color scheme can turn red for high, green for low, yellow for medium. The color scheme can be based on a carbon level threshold that can be a predefined number such as 0.8 for high, 0.5 for medium, and 0.3 for low. The CPC level can be an aggregation of the carbon-relevant data that can be collected for the monitored entity that can include product-level carbon product, physical activity level carbon product and economic activity-level carbon product. The amount of carbon-relevant data that can be collected can vary depending on the carbon production contribution level. For example, if the CPC level is high, the detail of physical or economic activity, such as carbon product of shipping or manufacturing, can be collected. The agent can compute the CPC level. The agent can also learn the patterns of the carbon-relevant data and create a prediction of the CPC level of the monitored entity based on past data.

Referring now to block 123 of FIG. 2 showing a method of associating the carbon product contribution level to the goal of the monitored entity to obtain a goal contribution metric, in accordance with an embodiment of the present invention.

The goal contribution metric can represent whether the CPC level for the monitored entity is relevant to its goal. To associate the CPC level to a goal, the goal is processed to understand its semantic meaning. Logical reasoning can be employed to associate the CPC level to the goal by employing probabilistic graphical models such as Bayesian networks. The model can output the goal contribution metric as a numerical value as a prediction of the association between the CPC level and the goal. The agent can include the probabilistic graphical model.

For example, for a supply chain system for cars that includes a monitored entity producing widget A used for cars, the goal for the monitored entity can include selling more widget A for cars. In this example, producing widget A can produce 1 kg of carbon units per widget A produced. However, in the supply chain system for cars, the monitored entity for widget A only produces 1% of the total carbon footprint of the supply chain system which in turn categorizes the monitored entity having a CPC level of low. Because the CPC level of the monitored entity is low compared to the whole supply chain system, the goal contribution metric can also be categorized as low having a numerical value of 0.01.

Referring now to block 125 of FIG. 2 showing a method of selecting calculation routes based on the goal contribution metric and a route threshold, in accordance with an embodiment of the present invention.

The route threshold can be a predetermined number such as 0.8 for high or 0.3 for low. In the example above, the goal contribution metric of 0.01 can be categorized in the low route threshold. Based on the route threshold, a calculation route can be selected based on a route heuristic. In an embodiment, the route heuristic can be predefined. For example, a goal contribution metric within the low route threshold can allow the agent to select an equation-based calculation route while a goal contribution metric within the high route threshold can allow the agent to select a simulation-based calculation route.

Referring now to block 130 of FIG. 1 showing a method of calculating a carbon emission based on the carbon-relevant data and the calculation route by utilizing an agent-based simulation model that simulates a learned relationship between a supply chain system and the carbon-relevant data, in accordance with an embodiment of the present invention.

With the input data in place and the calculation method selected, MOGI can simulate a learned relationship of the supply chain system and the carbon relevant data, considering the agents, resources, and topology. Based on the simulation results and the selected calculation method, MOGI computes the carbon emissions associated with each segment of the supply chain. The tool then aggregates these segment-specific emissions to provide a holistic view of the supply chain's carbon footprint.

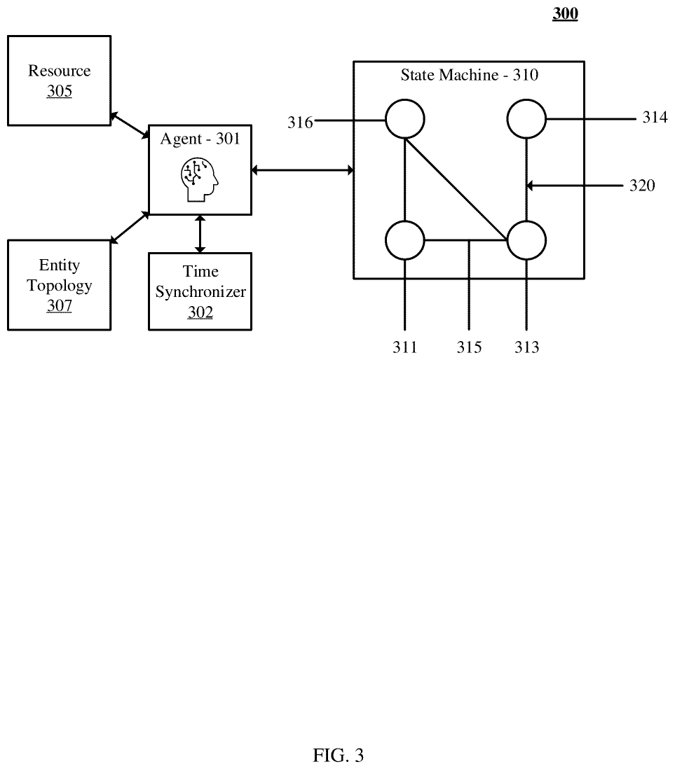

The simulation calculation route can include generating simulations to predict carbon product of the supply chain system based on state changes. To generate simulations, MOGI can decompose supply chain system into three parts, resource, topology, and agent. These components represent different part in supply chain and are constructed in advance in MOGI. To understand what each agent is doing or how it might react to the different environment, MOGI uses a state machine. The state machine can include a set of predefined rules that tells each agent what to do next based on its current situation. As things change, the agent knows exactly how to respond, ensuring the simulation is as close to real-life as possible. The state machine 310 can include a graph neural network (GNN). This is shown in more detail in FIG. 3.

Referring now to FIG. 3, showing a block diagram of a system depicting an agent learning appropriate actions based on a state machine, in accordance with an embodiment of the present invention.

System 300 can include an agent 301, state machine 310, time synchronizer 302, entity topology 307, resource 305. The entity topology 307 can represent the current hierarchy of the supply chain system. The resource 305 can represent the carbon-relevant data produced by the supply chain system.

The state machine 310 can include learned heuristics that can be represented by graph 320 that can have states represented by nodes and edges that represent relationships between nodes. For example, state B 311 can represent product demand for product A, state D 313 can represent the product supply for product A and edge 315 can represent the relationship between state B 311 and state D 313. State C 314 can represent a global change in the market such as a pandemic. Based on learned heuristics, the state machine 310 can provide resulting state A 316 based on state B 311, state C 314 and state D 313. State A 316 can represent the effect of the pandemic to the product supply and demand for product A. State A 316 can include increased/decreased product demand, increased/decreased product supply, no change in product demand or supply. The states 311, 313, 314 can have weights assigned to them that can represent the level of the state. For example, a positive weight such as 2, 2.5, etc., can represent an increase of the state. A negative weight can represent a decrease of the state.

The learned heuristics can include relevant rules for the current technical field MOGI is applied to such as market force rules. The learned heuristics can include rules that are learned by the system based on historical data. The learned heuristics can be stored in a heuristics database which can be included in the state machine 310. Examples of state changes can include large-scale phenomenon such as a pandemic, geopolitical, manufacturing changes based on new production process, etc.

For example, a forecasted severe weather event can increase the demand for bread and milk. In this example, due to the increase of demand for bread and milk, suppliers of milk, grains, and other raw ingredients of bread are strained which can increase the carbon product for such suppliers. Based on the increased carbon product for such suppliers, the agent 301 can update the resource 305 and entity topology to account for the increased carbon product. The agent 301 can learn this process.

In another example, a technological progress in artificial intelligence (AI) can decrease the supply of microchips and increase demand for microchips. In this example, the demand for microchips can put a strain in the production process of vehicles that also require microchips which can lower the carbon production of new vehicles as fewer vehicles can be produced as a result. Based on the decreased carbon product for new vehicles, the agent 301 can update the resource 305 and entity topology to account for the decreased carbon product for new vehicles.

The time synchronizer 302 can cluster states that affect the resource 305, and the entity topology 307. The time synchronizer 302 can cluster states based on the timeframe the event happened, the resource affected, the entity topology affected, the rules learned, the rules updated, rules created, etc.

Based on the learned heuristics, the agent 301 can predict outcomes dynamically from the state changes occurring due to the large-scale phenomenon. Based on these predicted outcomes, the agent 301 can also simulate scenarios based on a state change (e.g., similar to the examples for bread and technological progress in AI, etc.).

The equation calculation route can include industry standard computation of carbon production such as the product of emission data, activity data, and the emission factor. The emission data can include actual carbon product emitted. The activity data can include money spent on the process which produced the emission data such as trucking, shipping, manufacturing, etc. The emission factor can include carbon emission per unit of money spent. To calculate the total carbon footprint of the supply chain system, the carbon product produced by each monitored entity can be aggregated.

Referring now to block 140 of FIG. 1 showing a method of performing a corrective action to the monitored entities based on the carbon emission to limit a carbon product below a carbon product threshold, in accordance with an embodiment of the present invention.

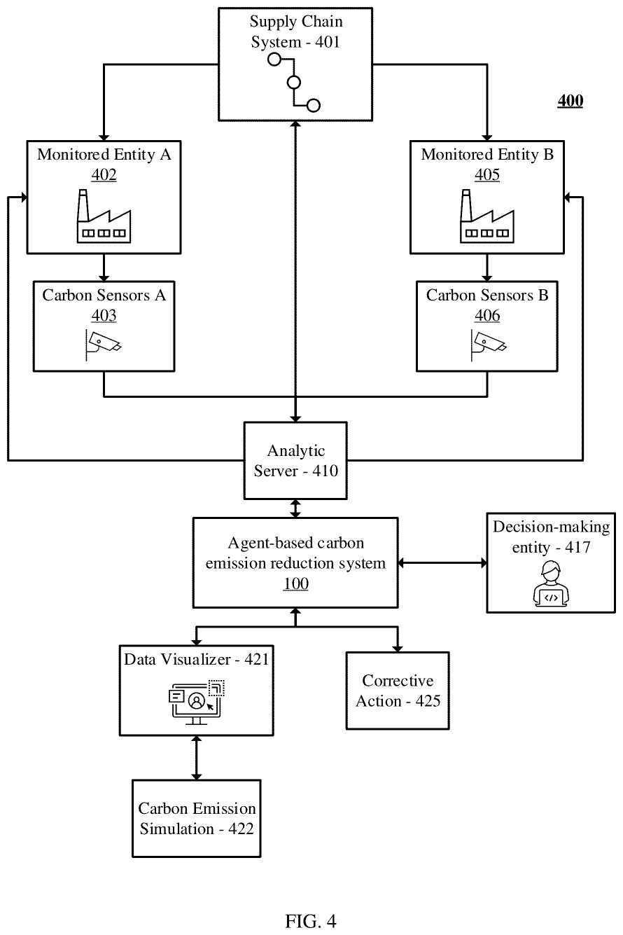

With the carbon emission data, MOGI can perform corrective action to limit a carbon product below a carbon product threshold. The carbon product threshold can be a predefined number that can be set by decision-making entities such as 100,000 kg carbon dioxide (CO2) unit. To perform corrective action, MOGI can identify areas within the supply chain with high emissions and suggest potential interventions or updates to reduce the carbon footprint of the supply chain system. This is described in more detail in FIG. 4.

Referring now to FIG. 4, a block diagram showing a system implementing a practical application of the agent-based carbon emission reduction system, in accordance with an embodiment of the present invention.

System 400 can include a supply chain system 401 that further includes monitored entity A 402, and monitored entity B 405 and their respective carbon sensors A 403 and carbon sensors B 406. The carbon sensors A 403 can collect carbon-relevant data from monitored entity A 402 which can be sent to the analytic server 410. The carbon sensors B 406 can collect carbon-relevant data from monitored entity B 405 which can be sent to the analytic server 410.

The analytic server 410 can be implemented with a connected network such as a cloud service, centralized server, closed networks, etc. Other network implementations can be used. The analytic server 410 can include an implementation of the agent-based carbon emission reduction system (MOGI) 100.

MOGI can include an online monitoring system with a data visualizer 421. The data visualizer 421 can allows a decision-making entity 417 to load historical data and compare the current running results of MOGI. Once the normal profiling models are trained, extreme adaptive data sampling (XADS) can be employed to either load testing data or receive streaming data from network and conduct online monitoring. MOGI 100 can provide the geographical location of all the monitored entities and a real-time simulation output. The baseline and current simulated data can be shown in different colors respectively.

In an embodiment of the data visualizer 421, the data visualizer 421 can include a control panel which can generate simulations and check outputs in real time. The data visualizer 421 can include comparison data in “baseline” and the simulations which can include products moving through the monitored entities within the supply chain system.

MOGI 100 can also implement corrective action 425 for the supply chain system 401. Corrective action 425 can include changing an operational parameter of an application or hardware component (e.g., an operating speed, workflow, etc.) for the supply chain system 401, halting and/or restarting an application for the supply chain system 401, halting and/or rebooting a hardware component for the supply chain system 401, changing an environmental condition for the supply chain system 401, etc. For example, in a supply chain system for widget A that can be used for cars, MOGI can identify that redirecting the process from processing plant wing A to processing plant wing B can lower the carbon footprint of the supply chain system by 10%. In this example, processing plant wing B can employ less mechanized arms which utilizes less electricity which ultimately produces less carbon footprint. In another embodiment, MOGI can recommend the corrective action 425 to decision making entities 417 which can implement updates to the supply chain.

In another embodiment, decision-making entities 417 (e.g., stakeholders of the supply chain system, factory foremen, maintenance workers, etc.) can leverage MOGI to generate carbon emission simulations 422 to explore the potential impact of different corrective action 425. According to different corrective action goals, MOGI can produce optimized business operations to make the whole system efficient and environmentally friendly.

The corrective action 425 can be performed until the carbon product of the supply chain system is below a carbon product threshold. The carbon product threshold can be set by the decision-making entity 417 as a numerical value, or a range. For example, in the example above, the carbon product threshold can be set to 10% which is met by performing the corrective action 425 of redirecting the process from processing plant wing A to processing plant wing B once.

Thus, the present embodiments can improve carbon emission reduction systems by considering dynamic changes in the supply chain system which achieves better accuracy in carbon emission calculation and provides explainable calculation results.

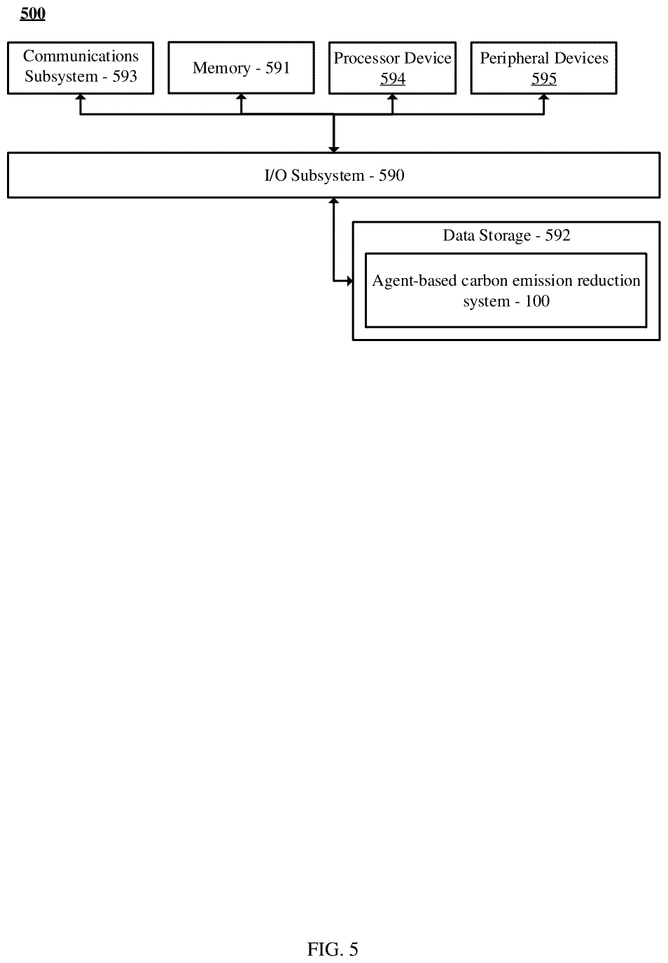

Referring now to FIG. 5, a block diagram illustrating a computing device implementing the agent-based carbon emission reduction system, in accordance with an embodiment of the present invention.

The computing device 500 illustratively includes the processor device 594, an input/output (I/O) subsystem 590, a memory 591, a data storage device 592, and a communication subsystem 593, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 591, or portions thereof, may be incorporated in the processor device 594 in some embodiments.

The processor device 594 may be embodied as any type of processor capable of performing the functions described herein. The processor device 594 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 591 may be embodied as any type of volatile or non-volatile memory or data storage capable of performing the functions described herein. In operation, the memory 591 may store various data and software employed during operation of the computing device 500, such as operating systems, applications, programs, libraries, and drivers. The memory 591 is communicatively coupled to the processor device 594 via the I/O subsystem 590, which may be embodied as circuitry and/or components to facilitate input/output operations with the processor device 594, the memory 591, and other components of the computing device 500. For example, the I/O subsystem 590 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 590 may form a portion of a system-on-a-chip (SOC) and be incorporated, along with the processor device 594, the memory 591, and other components of the computing device 500, on a single integrated circuit chip.

The data storage device 592 may be embodied as any type of device or devices configured for short-term or long-term storage of data such as, for example, memory devices and circuits, memory cards, hard disk drives, solid state drives, or other data storage devices. The data storage device 592 can store program code for the agent-based carbon emission reduction system (MOGI) 100. Any or all of these program code blocks may be included in a given computing system.

The communication subsystem 593 of the computing device 500 may be embodied as any network interface controller or other communication circuit, device, or collection thereof, capable of enabling communications between the computing device 500 and other remote devices over a network. The communication subsystem 593 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 595. The peripheral devices 595 may include any number of additional input/output devices, interface devices, and/or other peripheral devices. For example, in some embodiments, the peripheral devices 595 may include a display, touch screen, graphics circuitry, keyboard, mouse, speaker system, microphone, network interface, and/or other input/output devices, interface devices, GPS, camera, and/or other peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 500 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

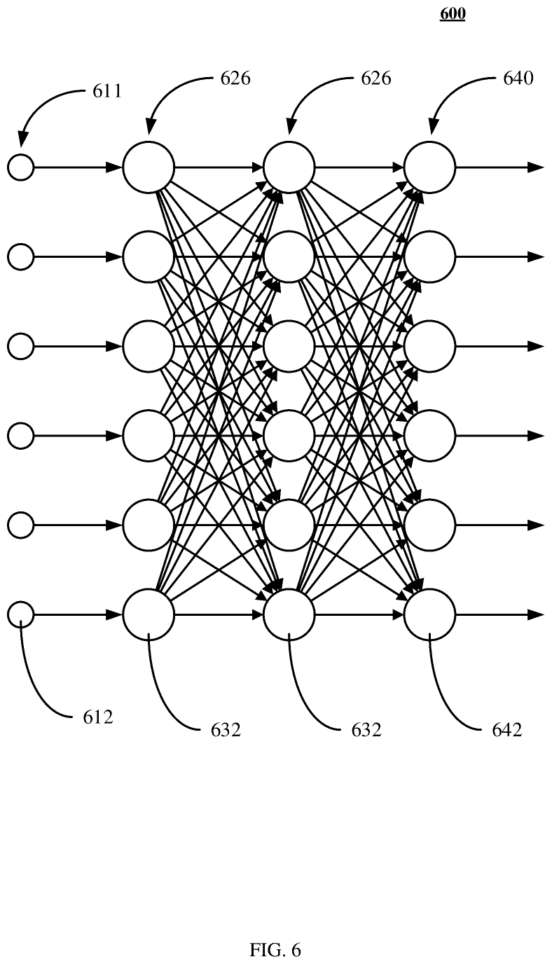

Referring now to FIG. 6, a block diagram illustrating deep learning neural networks for the agent-based carbon emission reduction system, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 600, such as a multilayer perceptron, can have an input layer 611 of source neurons 612, one or more computation layer(s) 626 having one or more computation neurons 632, and an output layer 640, where there is a single output neuron 642 for each possible category into which the input example could be classified. An input layer 611 can have a number of source neurons 612 equal to the number of data values 612 in the input data 611. The computation neurons 632 in the computation layer(s) 626 can also be referred to as hidden layers, because they are between the source neurons 612 and output neuron(s) 642 and are not directly observed. Each neuron 632, 642 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 626 of the GNN of the state machine 310 can learn relationships between states and ground truth data obtained from the entity topology 307 and resource 305. The output layer 640 of the GNN of the state machine 310 can then provide the overall response of the network as a likelihood score of a prediction of a future event based on the states and the ground truth data obtained from the entity topology 307 and resource 305. In another embodiment, the probabilistic graphical model of the agent can learn relevance between the semantic meaning of a textual representation of a monitored entity's goal and the CPC level, which outputs the goal contribution metric as the likelihood of the association.

Training a deep neural network can involve two phases, a forward phase where the weights of each neuron are fixed and the input propagates through the network, and a backwards phase where an error value is propagated backwards through the network and weight values are updated.

The computation neurons 632 in the one or more computation (hidden) layer(s) 626 perform a nonlinear transformation on the input data 612 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for reducing carbon emissions using an agent-based system, comprising:
extracting carbon-relevant data from monitored entities;
determining a calculation route based on the carbon-relevant data based on a relevance of a carbon product contribution of the monitored entities to a goal of the monitored entities;
calculating a carbon emission based on the carbon-relevant data and the calculation route by utilizing an agent-based simulation model that simulates a learned relationship between a supply chain system and the carbon-relevant data; and
performing a corrective action to the monitored entities based on the carbon emission to limit a carbon product of a supply chain system below a carbon product threshold.

2. The computer-implemented method of claim 1, wherein performing the corrective action further comprises changing an operational parameter of a hardware component used by the monitored entity of the supply chain system.

3. The computer-implemented method of claim 1, wherein extracting the carbon-relevant data further comprises generating a monitored entity profile for the monitored entities.

4. The computer-implemented method of claim 1, wherein determining the calculation route further comprises associating a carbon product contribution level produced by the monitored entities to the goal of the monitored entities to obtain a goal contribution metric.

5. The computer-implemented method of claim 4, wherein determining the calculation route further comprises selecting calculation routes based on the goal contribution metric and a route threshold.

6. The computer-implemented method of claim 1, where calculating the carbon emission further comprises generating carbon emission simulations to predict the carbon product of the supply chain system based on state changes.

7. The computer-implemented method of claim 6, wherein calculating the carbon emission further comprises learning heuristics for the state changes using a state machine.

8. A system, comprising:
a memory device;
one or more processor devices operatively coupled with the memory device to:
extract carbon-relevant data from monitored entities;
determine a calculation route based on the carbon-relevant data based on a relevance of a carbon product contribution of the monitored entities to a goal of the monitored entities;
calculate a carbon emission based on the carbon-relevant data and the calculation route by utilizing an agent-based simulation model that simulates a learned relationship between a supply chain system and the carbon-relevant data; and
perform a corrective action to the monitored entities based on the carbon emission to limit a carbon product of a supply chain system below a carbon product threshold.

9. The system of claim 8, wherein to perform the corrective action further comprises to change an operational parameter of a hardware component used by the monitored entity of the supply chain system.

10. The system of claim 8, wherein to extract the carbon-relevant data further comprises to generate a monitored entity profile for the monitored entities.

11. The system of claim 8, wherein to determine the calculation route further comprises to associate a carbon product contribution level produced by the monitored entities to a goal of the monitored entity to obtain a goal contribution metric.

12. The system of claim 11, wherein to determine the calculation route further comprises to select calculation routes based on the goal contribution metric and a route threshold.

13. The system of claim 8, wherein to calculate the carbon emission further comprises to generate carbon emission simulations to predict the carbon product of the supply chain system based on state changes.

14. The system of claim 13, wherein calculating the carbon emission further comprises learning heuristics for the state changes using a state machine.

15. A non-transitory computer program product comprising a computer-readable storage medium including program code for an agent-based carbon emission reduction system, wherein the program code when executed on a computer causes the computer to:
extract carbon-relevant data from monitored entities;
determine a calculation route based on the carbon-relevant data based on a relevance of a carbon product contribution of the monitored entities to a goal of the monitored entities;
calculate a carbon emission based on the carbon-relevant data and the calculation route by utilizing an agent-based simulation model that simulates a learned relationship between a supply chain system and the carbon-relevant data; and
perform a corrective action to the monitored entities based on the carbon emission to limit a carbon product of a supply chain system below a carbon product threshold.

16. The non-transitory computer program product of claim 15, wherein to perform the corrective action further comprises to change an operational parameter of a hardware component used by the monitored entity of the supply chain system.

17. The non-transitory computer program product of claim 15, wherein to extract the carbon-relevant data further comprises to generate a monitored entity profile for the monitored entities.

18. The non-transitory computer program product of claim 15, wherein to determine the calculation route further comprises to associate a carbon product contribution level produced by the monitored entities to a goal of the monitored entity to obtain a goal contribution metric.

19. The non-transitory computer program product of claim 18, wherein to determine the calculation route further comprises to select calculation routes based on the goal contribution metric and a route threshold.

20. The non-transitory computer program product of claim 15, where to calculate the carbon emission further comprises to generate carbon emission simulations to predict the carbon product of the supply chain system based on state changes.
